(19) United States
(12) Patent Application Publication
(10) Pub. No.: US 2019/0005808 A1
(43) Pub. Date: Jan. 3, 2019

(54) METHOD FOR THE UNIQUE ALLOCATION OF A REMOTE CONTROL TO A DEVICE SYSTEM

(71) Applicant: Hilti Aktiengesellschaft, Schaan (LI)

(72) Inventors: Peter Brugger, Feldkirch (AT); Wilfried Kaneider, Rankweil (AT); Georg Studer, Thueringen (AT)

(21) Appl. No.: 16/059,143

(22) Filed: Aug. 9, 2018

Related U.S. Application Data
(63) Continuation of application No. 15/538,553, filed on Jun. 21, 2017, now abandoned.

(30) Foreign Application Priority Data
Dec. 23, 2014 (EP) 14200010.8

(51) Int. Cl. G08C 17/02; B23Q 1/00; B28D 7/00

(52) U.S. Cl. CPC G08C 17/02; B28D 7/00; G08C 2201/20; B23Q 1/0045

(57) ABSTRACT

A method for the unique allocation of a first system component (14) of a device system (10), designed as a remote control, to a second and third system component (13, 12) of the device system (10), wherein the remote control (14) can be connected to the second system component (13) via a wireless and cableless communication link (35) or via a first cable or plug connection (36).

This is a Continuation of U.S. Ser. No. 15/538,553, filed Jun. 21, 2017 which is a National Phase application of International Patent Application PCT/EP2015/080951, filed Dec. 22, 2015 claiming priority to European Patent Application EP 14200010.8, filed Dec. 23, 2014. All of these applications are hereby incorporated by reference herein.

The present invention relates to a method for the unique allocation of a remote control to a device system, as well as a device system for carrying out a method of this type for the unique allocation.

### BACKGROUND

HUSQVARNA offers a device system designed as a wall sawing system, including a remote control, which is connectable to the wall sawing system via a radio link wirelessly and without cables. The remote control includes a first control unit and an input device, including control elements and input keys; the inputs on the input device are converted by the first control unit into control commands and data. The wall sawing system includes a guide rail, a power tool displaceably situated on the guide rail, an electronic assembly and the remote control. The power tool is designed as a wall saw and includes a saw head and a motor-driven feed unit. The saw head includes a cutting tool, which is designed as a saw blade, and is driven around a rotation axis by a drive motor. The motor-driven feed unit includes a guide carriage and a feed motor; the saw head is situated on the guide carriage and moved on the guide rail by the feed motor along a feed direction.

All electronic components for supplying and controlling the motors are situated in the electronic assembly. The electronic assembly includes a first electronic unit, which supplies the drive motor with electricity, and a first control element, which controls the drive motor, as well as another electronic unit, which supplies the feed motor with electricity, and another control element, which controls the feed motor. The control elements together form a second control unit for controlling the wall saw. The electronic assembly is connected to the remote control via a first communication link and to the wall saw via a second communication link. The first communication link is designed as a radio link or a first communication cable. The second communication link may be designed as a second communication cable, or the data and control lines of the second communication link may be integrated into a shared connecting cable between the electronic assembly and the wall saw together with the electrical supply lines. U.S. Patent application 2011/0056716 A1 from Husqvarna discloses details for designing a shared connecting cable between the electronic assembly and the wall saw.

As a safety measure, it is provided that an allocation between the remote control and the electronic assembly must be carried out the first time the remote control is turned on, and the remote control may be used only after the allocation is completed. The allocation is intended to ensure that an electronic assembly is controllable only from a remote control. The allocation of the remote control to the electronic assembly takes place via the first communication cable, which is designed as a CAN cable. The CAN cable is connected to the remote control and the electronic assembly to be connected, and the corresponding routine for the allocation is started on the remote control; a message as to whether the allocation between the remote control and the electronic assembly was or was not successful appears on the display of the remote control.

### SUMMARY OF THE INVENTION

The allocation implemented for the wall sawing system of Husqvarna has the disadvantage that the allocation takes place only between the remote control and the electronic assembly, and the wall saw is not taken into account by the allocation, so that different wall saws are controllable with the aid of the remote control. Each wall saw that is connected to the allocated electronic assembly via a suitable connecting cable is controlled via the remote control. A safety risk for the operator may result therefrom if the wall saw not expected by the operator is controlled with the aid of the remote control. The safety risk increases on crowded construction sites having multiple power tools and electronic assemblies.

It is an object of the present invention to increase the personal safety of the operator in device systems including a remote control which is connectable to the device system via a wireless and cableless communication link.

According to the present invention, in the method for uniquely allocating a first system component designed as a remote control to a second and a third system component of the device system, it is provided that

the second identification code is transmitted from the second system component to the third system component via a second cable or plug connection and is stored by the third system component as a second comparison code of the third system component; and

a third identification code of the third system component is transmitted from the third system component to the second system component and stored by the second system component as a third comparison code of the second system component.

In the method according to the present invention, the second and third system components of the device system are uniquely allocated to each other. Each system component of the device system is marked by a unique identification code, including the system components which are not connectable via a wireless and cableless communication link. The device system includes at least three system components: a first system component designed as a remote control, a second system component and a third system component.

In addition to the second identification code, the first identification code of the remote control is transmitted from the second system component to the third system component, and the first identification code is stored by the third system component as a first comparison code of the third system component. In addition to the second identification code, the third identification code of the third system component is particularly preferably transmitted from the second system component to the remote control, and the third identification code is stored by the remote control as a third comparison code of the first system component.

Safety during the operation of the device system may be additionally increased if not only the directly interconnected system components are uniquely allocated to each other but if all system components of the device system are uniquely allocated to each other. For this purpose, a unique allocation between the first and third system components takes place.

It is preferably provided that, during the data transmission between the first system component and the second system component, at least the identification code of the transmitting system component is also transmitted, and the transmitted identification code is compared by the receiving system component with the comparison code stored in the receiving system component. Due to the fact that the identification code of the transmitting system component is also transmitted during the data transmission, it may be ensured that control commands which are transmitted are executed only if the system components are uniquely allocated to each other and if the identification code was transmitted without errors.

In one preferred refinement, the comparison code of the receiving system component stored in the transmitting system component is additionally transmitted along with the identification code of the transmitting system component during the data transmission between the first and second system components, and the transmitted identification code is compared by the receiving system component with its own identification code stored in the receiving system component.

The device system is switched into a safe state if the transmitted identification codes deviate from the stored comparison codes. The cause of the deviation between the transmitted identification codes and the stored comparison codes is immaterial.

It is preferably provided that, during the data transmission between the second system component and the third system component, at least the identification code of the transmitting system component is also transmitted, and the transmitted identification code is compared by the receiving system component with the comparison code stored in the receiving system component.

In one preferred refinement, the comparison code of the receiving system component stored in the transmitting system component is additionally transmitted along with the identification code of the transmitting system component during the data transmission between the second and third system components and compared by the receiving system component with its own identification code stored in the receiving system component.

The device system is switched into a safe state if the transmitted identification codes deviate from the stored comparison codes. The cause of the deviation between the transmitted identification codes and the stored comparison codes is immaterial.

In one preferred refinement of the method, the third system component is connected to a fourth system component of the device system via a third cable or plug connection, a fourth identification code being transmitted from the fourth system component to the third system component and stored by the third system component as a fourth comparison code of the third system component, and the third identification code of the third system component being transmitted to the fourth system component and stored by the fourth system component as a third comparison code of the fourth system component.

The fourth identification code is particularly preferably transmitted from the third system component to the second system component and stored by the second system component as a fourth comparison code of the second system component, and the fourth identification code is subsequently transmitted from the second system component to the first system component and stored by the first system component as a fourth comparison code of the first system component. The first and second identification codes are particularly preferably transmitted from the third system component to the fourth system component, and the transmitted identification codes are stored by the fourth system component as the first and second comparison codes of the fourth system component.

In another refinement, the device system includes four system components: a first system component designed as a remote control, a second system component, a third system component and a fourth system component. The method for the unique allocation is transmitted to the fourth system component. The fourth system component is initially uniquely allocated to the directly connected third system component. Safety during the operation of the device system may be additionally increased if not only the directly interconnected system components are uniquely allocated to each other but if all system components of the device system are uniquely allocated to each other. For this purpose, a unique allocation takes place between the first and fourth system components as well as between the second and fourth system components.

The device system for carrying out a method for the unique allocation is characterized in that the safety unit additionally uniquely allocates the second system component and the third system component to each other. The device system includes at least three system components: a first system component designed as a remote control, a second system component and a third system component. Every system component of the device system is marked by a unique identification code, including the system components which are not connectable via a wireless and cableless communication link.

The safety unit preferably additionally uniquely allocates the remote control and the third system component to each other. Safety during the operation of the device system may be additionally increased if not only the directly interconnected system components (first and second system components as well as second and third system components) are uniquely allocated to each other but if all system components of the device system are uniquely allocated to each other. For this purpose, a unique allocation between the first and third system components takes place.

In one preferred specific embodiment, the safety unit includes a first, second and third transceiver as well as a first, second and third memory element, the first transceiver and the first memory element being situated in the remote control, the second transceiver and the second memory element being situated in the second system component and the third transceiver and the third memory element being situated in the third system component.

The first and third memory elements particularly preferably each have at least one memory location, and the second memory element has at least two memory locations for storing comparison codes, the first memory element storing a second comparison code of the second system component, the second memory element storing a first comparison code of the remote control and a third comparison code of the third system component, and the third memory element storing a second comparison code of the second system component.

The first and third memory elements each particularly preferably have at least two memory locations for storing comparison codes, the first memory element additionally storing a third comparison code of the third system component, and the third memory element additionally storing a first comparison code of the remote control.

In a first preferred embodiment, the third system component is designed as a power tool, including a cutting unit, which includes a cutting tool and a drive motor, and including a motor-driven feed unit, which includes a guide carriage and a feed motor, and the second system component is designed as an electronic assembly, including an electronic unit and a control element for the cutting unit and an electronic unit and a control element for the motor-driven feed unit.

In a second preferred embodiment, the third system component is designed as a cutting unit, including a cutting tool, a drive motor, a third electronic unit and a third control unit, and the second system component is designed as a motor-driven feed unit, including a guide carriage, a feed motor, a second electronic unit and a second control unit.

In a third preferred embodiment, the device system includes a fourth system component, which is connectable to the third system component of the device system via a third cable or plug connection, the safety unit of the device system additionally including a fourth transceiver and a fourth memory element, which are situated in the fourth system component.

The fourth system component is particularly preferably designed as a cutting unit, which includes a cutting tool and a drive motor, the third system component is designed as a motor-driven feed unit, which includes a feed motor, and the second system component is designed as an electronic assembly, which includes an electronic unit and a control element for the cutting unit and an electronic unit and a control element for the motor-driven feed unit.

### BRIEF DESCRIPTION OF THE DRAWINGS

Exemplary embodiments of the present invention are described below on the basis of the drawing. The latter is not necessarily intended to represent the exemplary embodiments true to scale but rather the drawing is presented in a schematic and/or slightly distorted form where useful for the purpose of explanation. With regard to additions to the teachings directly apparent from the drawing, reference is hereby made to the relevant prior art. It should be taken into account that a variety of modifications and changes relating to the form and detail of a specific embodiment may be undertaken without deviating from the general idea of the present invention. The features of the present invention disclosed in the description, the drawing and the claims may be essential to the refinement of the present invention both individually and in any arbitrary combination. All combinations of at least two of the features disclosed in the description, the drawing, and/or the claims are also within the scope of the present invention. The general idea of the present invention is not limited to the exact form or the detail of the preferred specific embodiment illustrated and described below, nor is it limited to an object which would be limited in comparison to the object claimed in the claims. In given measurement ranges, values within the specified limits are also to be disclosed as limiting values and be able to be arbitrarily used and claimed. For the sake of simplicity, the same reference numerals are used below for identical or similar parts or for parts having identical or similar functions.

FIG. 1 shows a first specific embodiment of a device system according to the present invention, which is designed as a wall sawing system, including a remote control, an electronic assembly and a wall saw;

FIGS. 2A, 2B show a second specific embodiment of a device system according to the present invention, designed as a core drilling system, including a remote control, a motor-driven feed unit and a drill head (FIG. 2A) as well as the structure of the drill head and the motor-driven feed unit in a schematic representation (FIG. 2B).

FIG. 3 shows a third specific embodiment of a device system according to the present invention, which is designed as a core drilling system, including a remote control, an electronic assembly, a motor-driven feed unit and a drill head;

FIG. 4 shows the device system of FIG. 1, including a safety unit, which carries out a unique allocation of the system components;

FIGS. 5A, 5B show the sequence of the method according to the present invention for the unique allocation with the aid of the safety unit; and

FIG. 6 shows a fourth specific embodiment of a device system according to the present invention, which is designed as a core drilling system, including a remote control, a first electronic assembly, a motor-driven feed unit, a second electronic assembly and a drill head.

### DETAILED DESCRIPTION

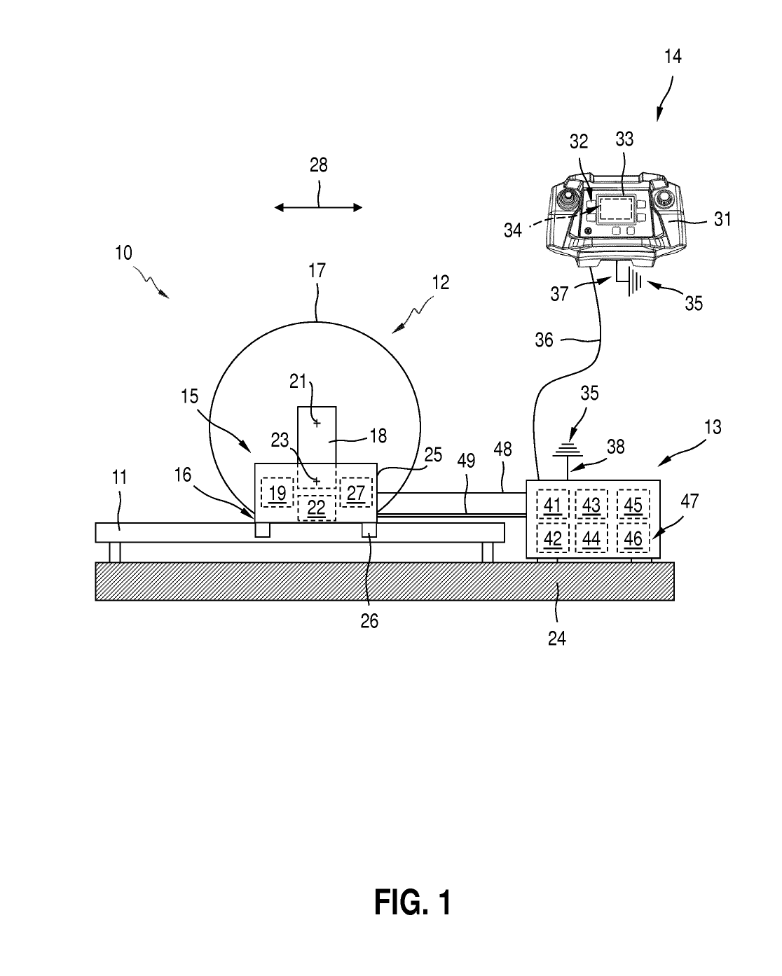

FIG. 1 shows a first specific embodiment of a device system 10 according to the present invention, which is designed as a wall sawing system, including three system components which are uniquely allocated to each other. Wall sawing system 10 includes a guide rail 11, a power tool 12, which is displaceably situated on guide rail 11, an electronic assembly 13 and a remote control 14. For the method according to the present invention for the unique allocation, remote control 14 forms the first system component, electronic assembly 13 forms the second system component, and power tool 12 forms the third system component of wall sawing system 10.

The power tool is designed as a wall saw 12 and includes a cutting unit designed as a saw head 15 and a motor-driven feed unit 16. Saw head 15 includes a cutting tool designed as a saw blade 17, which is fastened to a saw arm 18 and is driven around a rotation axis 21 by a drive motor 19. To protect the operator, saw blade 17 may be surrounded by a saw blade guard, which is fastened on saw arm 18 with the aid of a blade guard holder. Saw arm 18 is designed to be pivotable around a pivot axis 23 with the aid of a swing motor 22. The pivot angle of saw arm 18 determines, with the aid of a saw blade diameter of saw blade 17, how deep saw blade 17 dips into a workpiece 24 to be cut. Drive motor 19 and swing motor 22 are situated in a device housing 25. Motor-driven feed unit 16 includes a guide carriage 26 and a feed motor 27, which is also situated in device housing 25. Saw head 15 is fastened on guide carriage 26 and is designed to be displaceable by feed motor 27 along guide rail 11 in parallel to a feed direction 28 (double arrow).

Remote control 14 includes a device housing 31, an input device 32, a display device 33 and a first control unit 34, which is situated in the interior of device housing 31. First control unit 34 converts the inputs via input device 32 into control commands and data transmitted to electronic assembly 13 via a first communication link. The first communication link is optionally designed as a wireless and cableless communication link 35 or as a first cable connection 36. First cable connection 36 is used, in particular, when a wireless and cableless communication is prohibited for safety reasons, for example in hospitals and airports, or when sources of interference hinder the wireless and cableless communication. First cable connection 36 is also used to uniquely allocate remote control 14, electronic assembly 13 and wall saw 12 to each other with the aid of the method according to the present invention for unique allocation. The wireless and cableless communication link is designed in the exemplary embodiment as a radio link 35, which forms between a first radio unit 37 on remote control 14 and a second radio unit 38 on power tool 12. Alternatively, wireless and cableless communication link 35 may be designed in the form of an infrared, Bluetooth, WLAN or WiFi link; in addition to the listed wireless and cableless connecting technologies, all previously known and future wireless and cableless connecting technologies for transmitting data are suitable.

Electronic assembly 13 includes a first electronic unit 41, which supplies drive motor 19 with electricity, and a first control element 42, which controls drive motor 19, a second electronic unit 43, which supplies swing motor 22 with electricity, and a second control element 44, which controls swing motor 22, as well as a third electronic unit 45, which supplies feed motor 27 with electricity, and a third control element 46, which controls feed motor 27. First, second and third control elements 42, 44, 46 jointly form a second control unit 47. Electronic assembly 13 is connected to wall saw 12 via second communication link 48. In the exemplary embodiment, the second communication link is designed as a second cable connection 48. The electrical supply lines between electronic assembly 13 and wall saw 12 are accommodated in a separate supply cable 49. Alternatively, the data and control lines of the second communication link and the electrical supply lines of the supply cable may be integrated into a shared connecting cable.

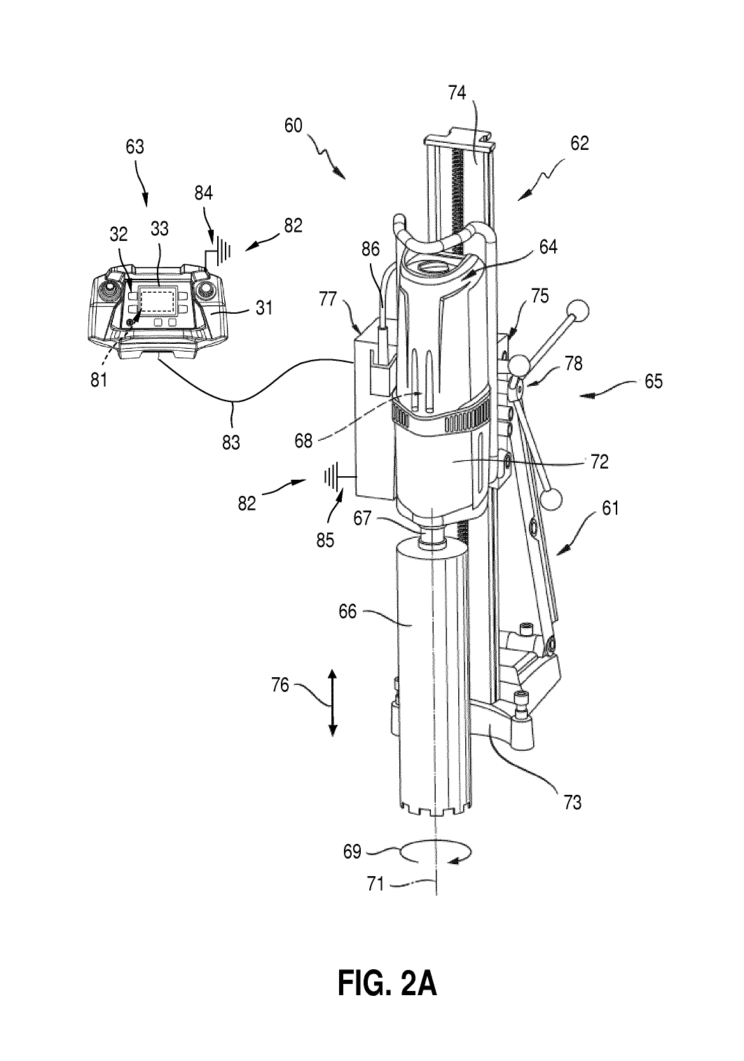

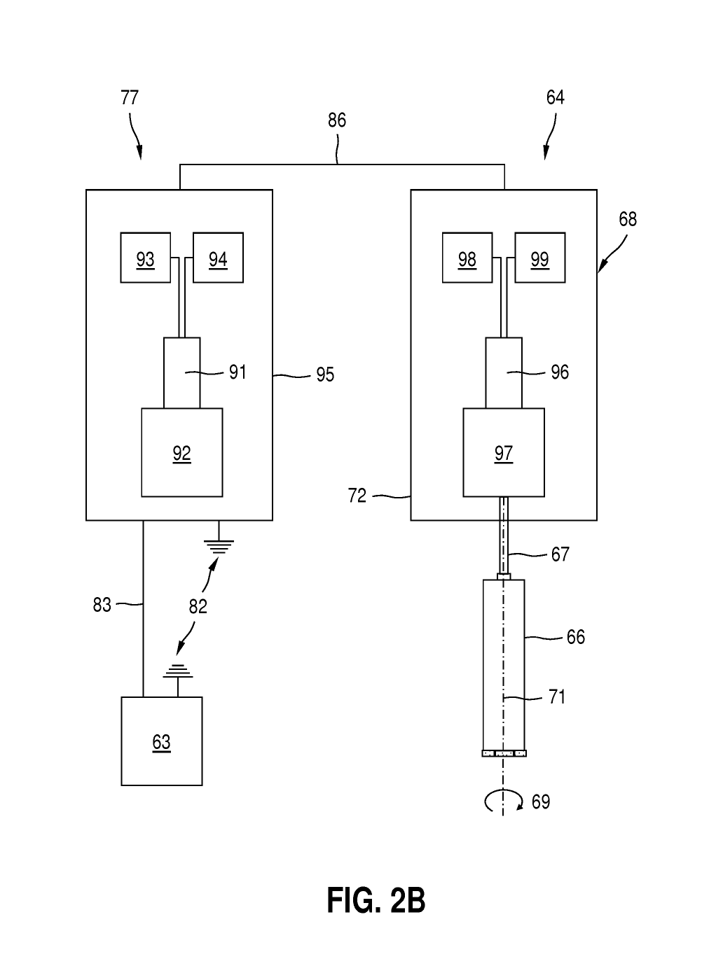

FIGS. 2A, 2B show a second specific embodiment of a device system 60 according to the present invention, which is designed as a core drilling system. Core drilling system 60 includes a power tool stand 61, a power tool 62, which is displaceably situated on power tool stand 61, and a remote control 63. The power tool is designed as a core drill 62 and includes a cutting unit 64 and a feed device 65.

The cutting unit is designed as a drill head 64 and includes a cutting tool designed as a core bit 66, which is situated on a drive shaft 67 and is driven by a drive unit 68 around a rotation axis 71 in a rotation direction 69. All drive components for drill bit 66, with the exception of drive shaft 67, are combined under the term “drive unit.” Drive unit 68 is situated in a device housing 72 of drill head 64.

Power tool stand 61 includes a base plate 73, which is fastened to a substrate, and a guide rail 74, which is connected to base plate 73. Drill head 64 is situated on power tool stand 61 via a guide carriage 75 and is displaceable with the aid of feed device 65 along guide rail 74 in parallel to a feed direction 76, which runs in parallel to rotation axis 71. Feed device 65 includes a motor-driven feed unit 77 and a manual feed unit 78 designed as a hand wheel. Drill head 64 may be optionally moved along guide rail 74 of power tool stand 61 with the aid of motor-driven feed unit 77 or manual feed unit 78.

Similarly to remote control 14 of wall sawing system 10, remote control 63 of core drilling system 60 is constructed from device housing 31, input device 32, display device 33 and a first control unit 81. First control unit 81 of remote control 63 is connected to drill head 64 via a first communication link. The first communication link is optionally designed as a wireless and cableless communication link 82 or as a first cable connection 83. The wireless and cableless communication link is designed in the exemplary embodiment as a radio link 82, which is established between a first radio unit 84 on remote control 63 and a second radio unit 85 on motor-driven feed unit 77.

Motor-driven feed unit 77 is connected to drill head 64 via a second communication link 86, the second communication link being designed in the exemplary embodiment as second cable connection 86. In the exemplary embodiment of FIG. 2A, first communication link 82, 83 connects remote control 63 to motor-driven feed unit 77, which, in turn, is connected to drill head 64 via second cable connection 86. Alternatively, remote control 63 may be connected to drill head 64, and drill head 64 may be connected to motor-driven feed unit 77.

FIG. 2B shows the structure of drive unit 68 of drill head 64 and motor-driven feed unit 77 of core drilling system 60 in a schematic representation. Motor-driven feed unit 77 moves drill head 64 along guide rail 74 in feed direction 76. Drill bit 66 is rotatably fixedly mounted on drive shaft 67 and is driven around rotation axis 72 by drive unit 68.

Motor-driven feed unit 77 includes a feed motor 91, a transmission unit 92, an electronic unit 93 for supplying feed motor 91 with electricity and a control unit 94 for controlling feed motor 91. Feed motor 91, transmission unit 92, electronic unit 93 and control unit 94 are situated in a device housing 95 of motor-driven feed unit 77.

Drive unit 68 includes a drive motor 96, another transmission unit 97, another electronic unit 98 for supplying drive motor 96 with electricity and another control unit 99 for controlling drive motor 96. Drive shaft 67 is driven around rotation axis 71 by drive motor 96 and additional transmission unit 97, additional transmission unit 97 being situated between drive motor 96 and drive shaft 67. Drive motor 96, additional transmission unit 97, additional electronic unit 98 and additional control unit 99 are situated in device housing 72 of drill head 64.

For the method according to the present invention for the unique allocation, remote control 63 forms the first system component, motor-driven feed unit 77 forms the second system component, and drill head 64 forms the third system component of core drilling system 60. Each system component 63, 77, 64 of core drilling system 60 includes a control unit and a device housing. To distinguish between the control units of remote control 63, motor-driven feed unit 77 and drill head 64, control unit 71 of remote control 63 is referred to as the first control unit, control unit 94 of motor-driven feed unit 77 is referred to as the second control unit, and control unit 99 of drill head 64 is referred to as the third control unit. In addition, device housing 31 of remote control 63 is referred to as the first device housing, device housing 95 of motor-driven feed unit 77 is referred to as the second device housing, and device housing 72 of drill head 64 is referred to as the third device housing.

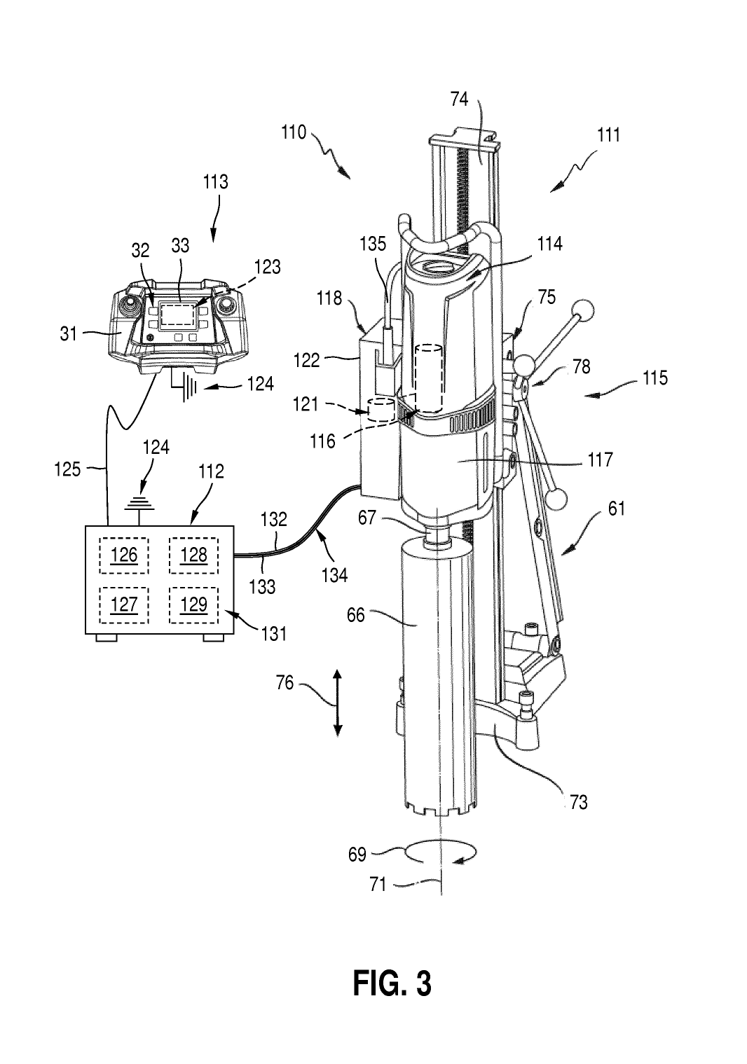

FIG. 3 shows a third specific embodiment of a device system 110 according to the present invention, which is designed as a core drilling system. Core drilling system 110 includes a power tool stand 61, a power tool 111, which is displaceably situated on power tool stand 61, an electronic assembly 112 and a remote control 113. The power tool is designed as a core drill 111 and includes a cutting unit 114 and a feed unit 115.

The cutting unit is designed as a drill head 111 and includes the cutting tool designed as a drill bit 66, which is situated on a drive shaft 67 and is driven by a drive motor 116 around a rotation axis 71 in rotation direction 69. Drive motor 116 illustrated schematically in FIG. 3 is situated in a device housing 117; all electronic components for supplying and controlling drive motor 116 are accommodated in electronic assembly 112. Drill bit 66 is rotatably fixedly mounted on drive shaft 67, and drive shaft 67 is driven around rotation axis 71 by drive motor 116. One or multiple transmission components may be connected between drive motor 116 and drive shaft 67.

Drill head 114 is situated on power tool stand 61 via guide carriage 75 and is displaceable with the aid of feed device 115 along guide rail 74 in parallel to a feed direction 76. Feed device 115 includes a motor-driven feed unit 118 and manual feed unit 78 designed as a hand wheel. Drill head 114 may be optionally moved along guide rail 74 with the aid of motor-driven feed unit 118 or manual feed unit 78. Motor-driven feed unit 118 includes a feed motor 121, which is situated in a device housing 122; all electronic components for controlling and supplying feed motor 121 are accommodated in electronic assembly 112.

Similarly to remote control 14, 63 of wall sawing system 10 in FIG. 1 and core drilling system 60 in FIG. 2, remote control 113 of core drilling system 110 is constructed from device housing 31, input device 32, display device 33 and a first control unit 123. Remote control 113 is connected to electronic assembly 112 via a first communication link. The first communication link is optionally designed as a wireless and cableless communication link 124 or as a first cable connection 125.

Electronic assembly 112 includes a first electronic unit 126, which supplies drive motor 116 with electricity, and a first control element 127, which controls drive motor 116, as well as a second electronic unit 128, which supplies feed motor 121 with electricity, and second control element 129, which controls the feed motor 121. First and second control elements 127, 129 jointly form a second control unit 131. Electronic assembly 112 is connected to motor-driven feed unit 118 via second communication link. In the exemplary embodiment, the second communication link is designed as a second cable connection 132, which is integrated into a connecting cable 134 together with electrical supply lines 133. Motor-driven feed unit 118 is connected to drill head 114 via a third communication link. In the exemplary embodiment, the third communication link is designed as a third cable connection 135.

For the method according to the present invention for the unique allocation, remote control 113 forms the first system component, electronic assembly 112 forms the second system component, motor-driven feed unit 118 forms the third system component and drill head 114 forms the fourth system component of core drilling system 110.

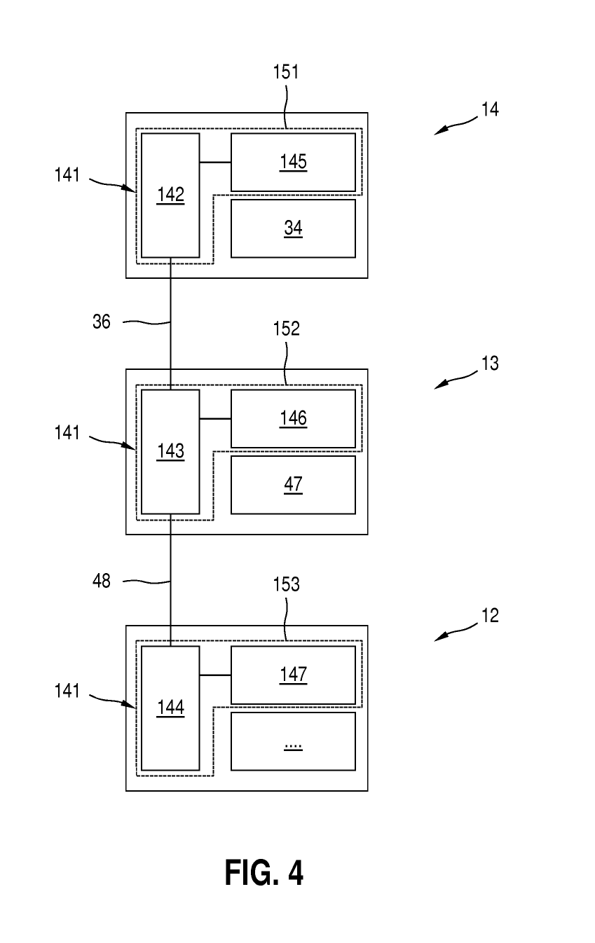

FIG. 4 shows the interaction between remote control 14 of electronic assembly 13 and power tool 12 in the unique allocation of system components 14, 13, 12 of device system 10 of FIG. 1. The method according to the present invention for the unique allocation is carried out only if remote control 14 is connected to electronic assembly 13 via first cable connection 36 and electronic assembly 13 is connected to power tool 12 via second cable connection 48.

The unique allocation of three system components 14, 13, 12 of device system 10 takes place with the aid of a safety unit 141. Remote control 14 represents the first system component, electronic assembly 13 represents the second system component, and power tool 12 represents the third system component of device system 10. Each system component 14, 13, 12 is marked by a unique identification code; remote control 14 is marked by a first identification code ID-1, electronic assembly 13 is marked by a second identification code ID-2 and power tool 12 is marked by a third identification code ID-3.

Safety unit 141 includes a first transceiver 142, a second transceiver 143 and a third transceiver 144 as well as a first memory element 145, a second memory element 146 and a third memory element 147. First transceiver 142 and first memory element 145 are situated in remote control 14 and form a first part 151 of safety unit 141, second transceiver 143 and second memory element 146 are situated in electronic assembly 13 and form a second part 152 of safety unit 141, and third transceiver 144 and third memory element 147 are situated in power tool 12 and form a third part 153 of safety unit 141. First, second and third parts 151, 152, 153 jointly form safety unit 141.

At least the identification codes of the directly connected system components are stored as comparison codes VCᵢ-j in each memory element. Comparison codes VCᵢ-j include two indexes, first index i, i=1 through 3 marking the storing system component, and second index j, j=1 through 3 marking the receiving system component. Remote control 14 is connected directly to electronic assembly 13 via first cable connection 36 and stores at least second identification code ID-2 of electronic assembly 13 as a second comparison code VC₁-2. Wall saw 12 is connected directly to electronic assembly 13 via second cable connection 48 and stores at least second identification code ID-2 of electronic assembly 13 as a second comparison code VC₃-2. Electronic assembly 13 is connected directly to remote control 14 and wall saw 12 and therefore stores first identification code ID-1 of remote control 14 as a first comparison code VC₂-1 and third identification code ID-3 of wall saw 12 as a third comparison code VC₂-3.

In one refinement, system components 14, 13, 12 not only store the identification codes of the directly connected system components as comparison codes, but the identification codes of all system components 14, 13, 12 of device system 10 are stored as comparison codes. In the exemplary embodiment, memory elements 145, 146, 147 each have three memory locations for storing identification codes. In addition to second comparison code VC₁-2 of remote control 14, third identification code ID-3 of power tool 12 is also stored in first memory element 145 as third comparison code VC₁-3 of remote control 14, and in addition to second comparison code VC₃-2 of power tool 12, first identification code ID-1 of remote control 14 is also stored in third memory element 147 as first comparison code VC₃-1 of power tool 12. As in the exemplary embodiment, identification codes ID-1, ID-2, ID-3 belonging to one system component 14, 13, 12 may be stored in another memory location of its own memory element 145, 146, 147 or in a different location in the control unit.

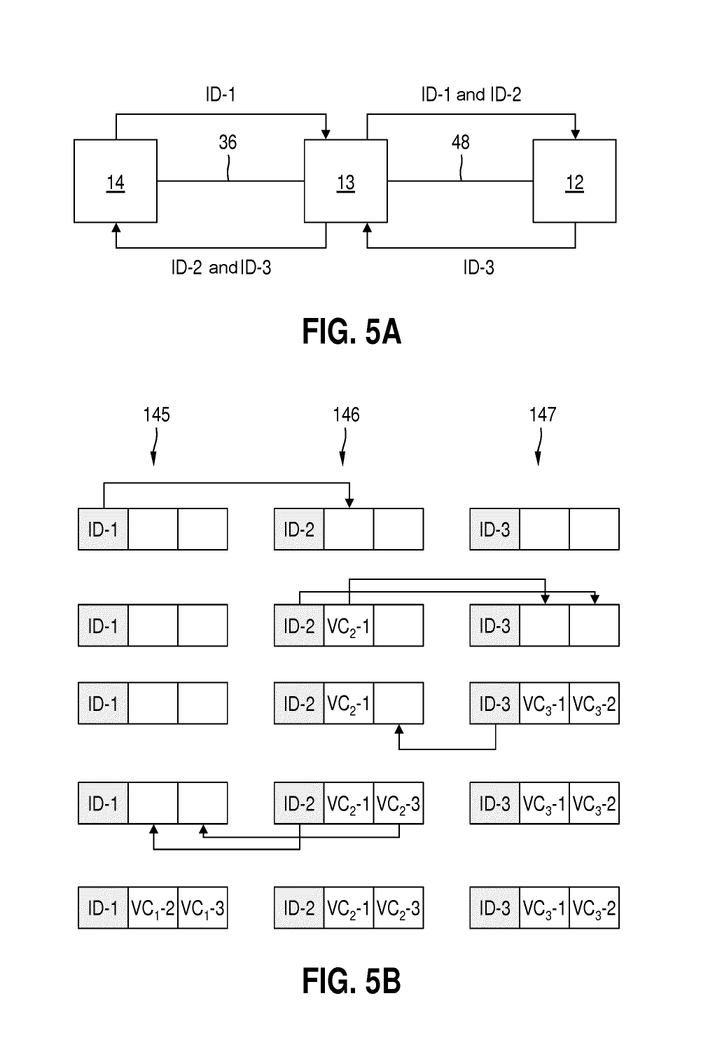

FIGS. 5A, 5B show the sequence of the individual method steps of the method according to the present invention for the unique allocation of remote control 14, electronic assembly 13 and power tool 12. FIG. 5A shows the interaction between three system components 14, 13, 12, and FIG. 5B shows memory elements 145, 146, 147 of three system components 14, 13, 12. FIG. 5B shows one specific embodiment of safety unit 141, in which system components 14, 13, 12 store all identification codes of system components 14, 13, 12 of device system 10, and the identification codes belonging to system components 14, 13, 12 are stored in memory elements 145, 146, 147. Remote control 14 is connected to electronic assembly 13 via first cable connection 36, and electronic assembly 13 is connected to power tool 12 via second cable connection 48. No direct communication link exists between remote control 14 and power tool 12; the communication takes place via electronic assembly 13.

First transceiver 142 transmits first identification code ID-1 of remote control 14 via first cable connection 36 to second transceiver 143, which stores first identification code ID-1 as first comparison code VC₂-1 in second memory element 146. Second transceiver 143 transmits first identification code ID-1 of remote control 14 and second identification code ID-2 belonging to electronic assembly 13 via second cable connection 48 to third transceiver 144, which stores first identification code ID-1 as first comparison code VC₃-1 of the third system component and second identification code ID-2 as second comparison code VC₃-2 of the third system component in third memory element 147. Third transceiver 144 transmits third identification code ID-3 of power tool 12 via second cable connection 48 to second transceiver 143, which stores third identification code ID-3 as third comparison code VC₂-3 of the second system component in second memory element 146. Second transceiver 143 transmits second identification code ID-2 of electronic assembly 13 and third identification code ID-3 of power tool 12 via first cable connection 36 to first transceiver 142, which stores second identification code ID-2 as second comparison code VC₁-2 of the first system component and third identification code ID-3 as third comparison code VC₁-3 of the first system component in first memory element 145.

Upon completing the method according to the present invention, the identification codes of system components 14, 13, 12 of device system 10 are stored in each memory element 145, 146, 147. To ensure that only system components 14, 13, 12 uniquely allocated to each other communicate with each other during operation, the identification codes are transmitted regularly during the data transmission and compared with the stored comparison codes by transceivers 142, 143, 144 of the system components. Control commands and data which are transmitted, for example from remote control 14 via first communication link 35 are executed only if first identification code ID-1 transmitted from remote control 14 matches first comparison code VC₂-1 of second system component stored in second memory element 146.

In one refinement of the method according to the present invention, not only the identification codes of system components 14, 13, 12 of device system 10 are transmitted, but additional information on the system components of device system 10 is also transmitted. This additional information includes, for example, device types and device-specific characteristic variables. If one remote control 14 is able to operate different power tools, different control methods must be stored in the control unit of the remote control. In practice, it is customary for a remote control to control, for example, a diamond wall saw and a diamond wire saw. Device-specific characteristic variables, which must be transmitted to the remote control, are required for controlled cutting. These characteristic variables may be entered by the operator, or the characteristic variables may be stored in the control unit of each system component and be transmitted upon the allocation of the system components. If remote control 14 is connected to a wall saw 12, only the control methods suitable for the present device type of wall saw 12 are displayed on remote control 14. No control methods which are unsuitable for wall saw 12 are displayed to the operator.

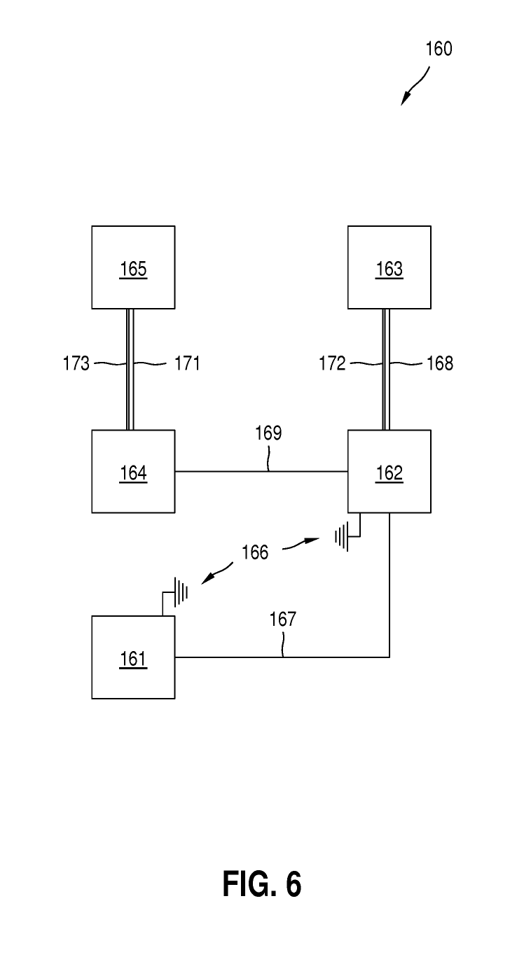

FIG. 6 shows a fourth specific embodiment of a device system according to the present invention, which is designed as a core drilling system 160, including five system components, and is illustrated in the form of a block diagram. Core drilling system 160 includes a remote control 161, a first electronic assembly 162, a motor-driven feed unit 163, a second electronic assembly 164 and a cutting unit designed as a drill head 165. For the method according to the present invention for the unique allocation of the system components, remote control 161 forms the first system component, first electronic assembly 162 forms the second system component, motor-driven feed unit 163 forms the third system component, second electronic assembly 164 forms the fourth system component, and drill head 165 forms the fifth system component of core drilling system 160. Each of five system components 161 through 165 of device system 160 is marked by a unique identification code.

Motor-driven feed unit 163 and drill head 165 of core drilling system 160 have a corresponding design to the system components of core drilling system 110 of FIG. 3; motor-driven feed unit 163 corresponds to motor-driven feed unit 118 including feed motor 121, and drill head 165 corresponds to drill head 114 including drive motor 116. Electronic components 126, 127 for supplying and controlling motor-driven feed unit 163 are situated in first electronic assembly 162, and electronic components 128, 129 for supplying and controlling drill head 165 are situated in second electronic assembly 164.

Remote control 161 is connected to first electronic assembly 162 via a first communication link, the first communication link being designed as wireless and cableless communication link 166 or as first cable connection 167. First electronic assembly 162 is connected to motor-driven feed unit 163 via a second communication link 168 and to second electronic assembly 164 via a third communication link 169. The second communication link is designed as second cable connection 168, and the third communication link is designed as third cable connection 169. Second electronic assembly 164 is connected to drill head 165 via a fourth communication link, which is designed as fourth cable connection 171.

The electrical supply of motor-driven feed unit 163 takes place via a first supply cable 172, which connects first electronic assembly 162 to motor-driven feed unit 163. As illustrated in FIG. 6, second cable connection 168 and first supply cable 172 may be designed as separate cables or alternatively be integrated into a shared first connecting cable. The electrical supply of drill head 165 takes place via a second supply cable 173, which connects second electronic assembly 164 to drill head 165. As illustrated in FIG. 6, fourth cable connection 171 and second supply cable 173 may be designed as separate cables or alternatively be integrated into a shared second connecting cable.

What is claimed is:

1. A method for the unique allocation of a first system component of a device system, designed as a remote control, to a second and a third system component of the device system, the remote control being connectable to the second system component via a wireless and cableless communication link or a first cable or plug connection, the method comprising the following steps:
connecting the remote control to the second system component via the first cable or plug connection;
transmitting a first identification code (ID-1) is transmitted from the remote control to the second system component, the first identification code (ID-1) being stored by the second system component as a first comparison code (VC₂-1) of the second system component;
transmitting a second identification code (ID-2) is transmitted from the second system component to the remote control, the second identification code (ID-2) being stored by the remote control as a second comparison code (VC₁-2) of the remote control;
transmitting the second identification code (ID-2) from the second system component to the third system component via a second cable or plug connection, the second identification code (ID-2) being stored by the third system component as a second comparison code (VC₃-2) of the third system component; and
transmitting a third identification code (ID-3) of the third system component from the third system component to the second system component, the third identification code (ID-3) being stored by the second system component as a third comparison code (VC₂-3) of the second system component.

2. The method as recited in claim 1 wherein, in addition to the second identification code (ID-2), the first identification code (ID-1) of the remote control is transmitted from the second system component to the third system component, and the first identification code (ID-1) is stored by the third system component as a first comparison code (VC₃-1) of the third system component.

3. The method as recited in claim 2 wherein, in addition to the second identification code (ID-2), the third identification code (ID-3) of the third system component is transmitted from the second system component to the remote control, and the third identification code (ID-3) is stored by the remote control as a third comparison code (VC₁-3) of the remote control.

4. The method as recited in claim 1 wherein, during the data transmission between the first system component and the second system component, at least the first or second identification code (ID-1, ID-2) of the transmitting first or second system component is also transmitted, and the first or second transmitted identification code (ID-1, ID-2) being compared by the receiving first or second system component with the first or second comparison code (VC₂-1, VC₁-2) stored in the receiving first or second system component.

5. The method as recited in claim 4 wherein, during the data transmission between the first and second system components, the first or second comparison code (VC₁-2, VC₂-1) of the receiving first or second system component stored in the transmitting first or second system component is also transmitted along with the identification code (ID-1, ID-2) of the transmitting first or second system component and compared by the receiving first or second system component with the first or second identification code (ID-2, ID-1) stored in the receiving first or second system component.

6. The method as recited in claim 4 wherein the device system is switched into a safe state if the transmitted first or second identification codes (ID-1, ID-2) deviate from the stored first or second comparison codes (VC₂-1, VC₁-2).

7. The method as recited in claim 1 wherein, during the data transmission between the second system component and the third system component, at least the second or third identification code (ID-2, ID-3) of the transmitting second or third system component is also transmitted, and the transmitted second or third identification code is compared by the receiving second or third system component with the second or third comparison code (VC₃-2, VC₂-3) stored in the receiving second or third system component.

8. The method as recited in claim 7 wherein, during the data transmission between the second and third system components, the second or third comparison code (VC₂-3, VC₃-2) of the receiving second or third system component stored in the transmitting second or third system component is also transmitted along with the second or third identification code (ID-2, ID-3) of the transmitting second or third system component and compared by the receiving second or third system component with the second or third identification code (ID-3, ID-2) stored in the receiving system component.

9. The method as recited in claim 8 wherein the device system is switched into a safe state if the transmitted second or third identification codes deviate from the stored second or third comparison codes (VC₃-2, VC₂-3).

10. The method as recited in claim 1 wherein the third system component is connected to a fourth system component of the device system via a third cable or plug connection, a fourth identification code being transmitted from the fourth system component to the third system component and stored by the third system component as a fourth comparison code (VC₃-4) of the third system component, and the third identification code (ID-3) of the third system component being transmitted to the fourth system component and stored by the fourth system component as a third comparison code (VC₄-3) of the fourth system component.

11. The method as recited in claim 10 wherein the fourth identification code (ID-4) is transmitted from the third system component to the second system component and stored by the second system component as a fourth comparison code (VC₂-4) of the second system component, and the fourth identification code (ID-4) is subsequently transmitted from the second system component to the first system component and stored by the first system component as a fourth comparison code (VC₁-4) of the first system component.

12. The method as recited in claim 10 wherein the first and second identification codes (ID-1, ID-2) are transmitted from the third system component to the fourth system component, and the transmitted identification codes (ID-1, ID-2) are stored by the fourth system component as first and second comparison codes (VC₄-1, VC₄-2) of the fourth system component.

13. A device system for carrying out the method as recited in claim 1, comprising:
the first system component designed as the remote control, including an input device and a first control unit converting inputs of the input device into control signals and data;
the second system component connectable to the remote control via a first communication link, the first communication link being designed as the wireless and cableless communication link or as the first cable or plug connection;
a third system component connectable to the second system component via a second communication link, the second communication link being designed as the second cable or plug connection; and
a safety unit uniquely allocating the remote control and the second system component to each other, the safety unit additionally uniquely allocating the second system component and the third system component to each other.

14. The device system as recited in claim 13 wherein the safety unit additionally uniquely allocates the remote control and the third system component to each other.

15. The device system as recited in claim 13 wherein the safety unit includes a first, second and third transceiver as well as a first, second and third memory element, the first transceiver and the first memory element being situated in the remote control, the second transceiver and the second memory element being situated in the second system component and the third transceiver and the third memory element being situated in the third system component.

16. The device system as recited in claim 15 wherein the first and third memory elements each have at least one memory location, and the second memory element has at least two memory locations for storing comparison codes, the first memory element storing the second comparison code (VC₁-2) of the second system component, the second memory element storing a first comparison code (VC₂-1) of the remote control and a third comparison code (VC₂-3) of the third system component, and the third memory element storing a second comparison code (VC₃-2) of the second system component.

17. The device system as recited in claim 16 wherein the first and third memory elements each have at least two memory locations for storing the comparison codes, the first memory element additionally storing a third comparison code of the third system component, and the third memory element additionally storing a first comparison code (VC₃-1) of the remote control.

18. The device system as recited in claim 13 wherein the third system component is designed as a power tool, including a cutting unit having a cutting tool and a drive motor, and including a motor-driven feed unit having a guide carriage and a feed motor, and the second system component is designed as an electronic assembly, including an electronic unit and a control element for the cutting unit and an additional electronic unit and an additional control element for the motor-driven feed unit.

19. The device system as recited in claim 13 wherein the third system component is designed as a cutting unit including a cutting tool, a drive motor, a third electronic unit and a third control unit, and the second system component is designed as a motor-driven feed unit including a feed motor, a second electronic unit and a second control unit.

20. The device system as recited in claim 13 further comprising a fourth system component connectable to the third system component via a third cable or plug connection, the safety unit additionally including a fourth transceiver and a fourth memory element situated in the fourth system component.

21. The device system as recited in claim 20 wherein the fourth system component is designed as a cutting unit includes a cutting tool and a drive motor, the third system component is designed as a motor-driven feed unit including a feed motor and the second system component is designed as an electronic assembly including a first electronic unit and a first control element for the cutting unit and a second electronic unit and a second control element for the motor-driven feed unit.
